(19) United States
(12) Patent Application Publication
(10) Pub. No.: US 2008/0079209 A1
(43) Pub. Date: Apr. 3, 2008

(54) Jig of vehicle door mounting apparatus performing biaxial movement

(76) Inventor: Ki-Nam yangjung-dong Kim, Buk-gu (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/646,080

(22) Filed: Dec. 26, 2006

(30) Foreign Application Priority Data
Sep. 29, 2006 (KR) 10-2006-0096055

(51) Int. Cl. B25B 1/20

(52) U.S. Cl. 269/37

(57) ABSTRACT

A slight displacement of a door hinge in lateral and longitudinal directions is adjusted while the door hinge is assembled to the vehicle body. A lower plate is coupled to the vehicle door mounting apparatus. First and second linear motion guide rails are fixed on the lower plate. First and second linear motion blocks are coupled on the first and second linear motion guide rails. First and second restricting devices are fixed on the lower plate and restrict movement of the first and second linear motion blocks. First and second stroke adjusters are fixed on the lower plate for adjusting a slight displacement of the first and second linear motion blocks. A pressure pipe having an opening and closing valve thereon supplies operation pressure to the first and second restricting devices.

### CROSS-REFERENCE TO RELATED APPLICATIONS

The present application is based on, and claims priority from, Korean Application Serial Number 10-2006-0096055, filed on Sep. 29, 2006, the disclosure of which is hereby incorporated by reference herein in its entirety.

### FIELD OF THE INVENTION

The present invention relates to a jig of a vehicle door mounting apparatus configured to perform a biaxial movement for adjusting a slight lateral and longitudinal displacement of a door hinge mounted on the door mounting apparatus for being assembled to the vehicle body.

### BACKGROUND OF THE INVENTION

Generally, a vehicle door is assembled by fixing one end of a door hinge to a door mounting apparatus, then carrying the other end of the hinge to a vehicle body mounting portion for a screw assembly. The door hinge should precisely fit on the vehicle body mounting portion to facilitate installation. However, the vehicle body mounting portion, which is transported via a conveyor, and the door hinge, which is delivered via the door mounting apparatus, are typically inconsistently placed to each other. Therefore, a worker must adjust the position of the door mounting apparatus for an accurate assembly of the door hinge onto the vehicle body mounting portion. The weight of the door mounting apparatus may cause injury to workers over time.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments of the present invention adjust a slight displacement of a door hinge in the lateral and longitudinal directions thereof while the door hinge is assembled via a vehicle door mounting apparatus to the vehicle body, thus precisely fitting the door hinge on the vehicle body mounting portion.

A jig of a vehicle door mounting apparatus performing a biaxial movement wherein the vehicle door mounting apparatus is mounted with one end of a door hinge and carries the other end of the hinge to a vehicle body mounting portion includes a lower plate coupled to the vehicle door mounting apparatus. A first linear motion guide rail is fixed on the lower plate in a lateral direction thereof. A first linear motion block is slidably coupled on the first linear motion guide rail. A first restricting device is fixed on the lower plate and restricts a movement of the first linear motion block. A first stroke adjuster is fixed on the lower plate for adjusting a slight displacement of the first linear motion block. A middle plate is coupled on the first linear motion block. A second linear motion guide rail is fixed on the middle plate in a longitudinal direction thereof. A second linear motion block is slidably coupled on the second linear motion guide rail. A second restricting device is fixed on the middle plate and restricts a movement of the second linear motion block. A second stroke adjuster is fixed on the middle plate and adjusts a slight displacement of the second linear motion block. An upper plate is placed on the second linear motion block and is mounted with the door hinge. A pressure pipe supplies the high operation pressure to the first and second restricting devices. An opening and closing valve is installed at the pressure pipe for adjusting the opening and closing of the pipe.

### BRIEF DESCRIPTION OF THE DRAWINGS

For a better understanding of the nature and objects of the present invention, reference should be made to the following detailed description with the accompanying drawings, in which:

FIG. 1 is a perspective view of a biaxially moving jig according to one embodiment of the present invention;

FIG. 2 is a perspective view of a slightly laterally moving jig as shown in FIG. 1;

FIG. 3 is an exploded perspective view of FIG. 2;

FIG. 4 is a perspective view of a slightly longitudinally moving jig as shown in FIG. 1;

FIG. 5 is an exploded perspective view of FIG. 4;

FIG. 6 is a perspective view of a stroke adjuster according to an embodiment of the present invention;

FIG. 7 is an exploded perspective view of FIG. 6; and

FIG. 8 illustrates a restricting device applied to a linear motion block.

### DETAILED DESCRIPTION OF THE PREFERRED EMBODIMENTS

A vehicle door mounting apparatus is mounted with one end of a door hinge and delivers the other end of the hinge to a vehicle body mounting portion for an assembly thereof. A biaxial jig is configured to slightly laterally and longitudinally move the door hinge in relation to the vehicle body mounting portion. The biaxial jig includes a slightly laterally moving jig and a slightly longitudinally moving jig.

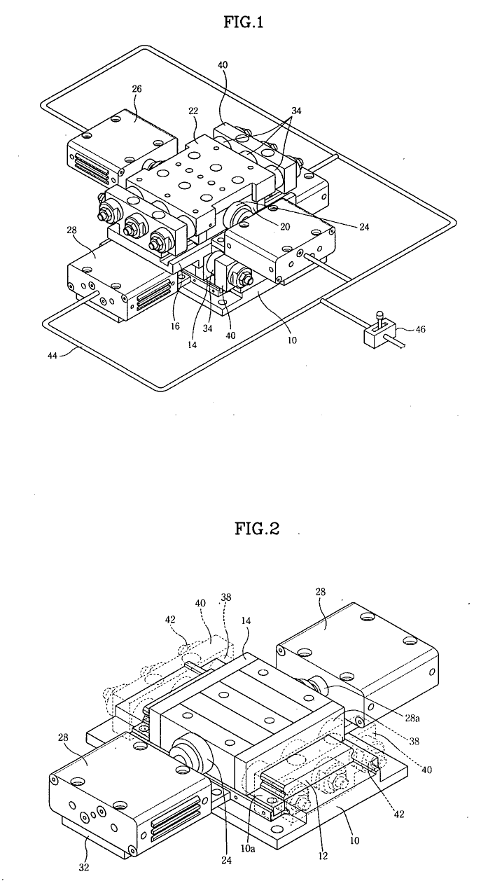

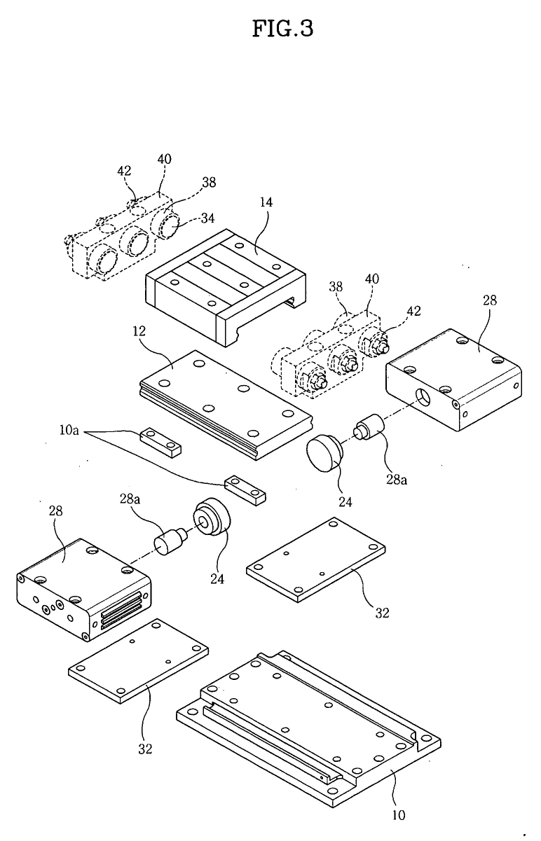

Referring to FIGS. 2 and 3, the slightly laterally moving jig includes a lower plate 10 coupled to an actuator of the vehicle door mounting apparatus. A first linear motion guide rail 12 is fixed on lower plate 10 in a lateral direction thereof. A first linear motion block 14 is slidably coupled on first linear motion guide rail 12. A first restricting device is fixed on lower plate 10 and restricts a movement of first linear motion block 14 in relation to first linear motion guide rail 12. A first stroke adjuster is fixed on lower plate 10 for adjusting a slight displacement of first linear motion block 14 in relation to first linear motion guide rail 12.

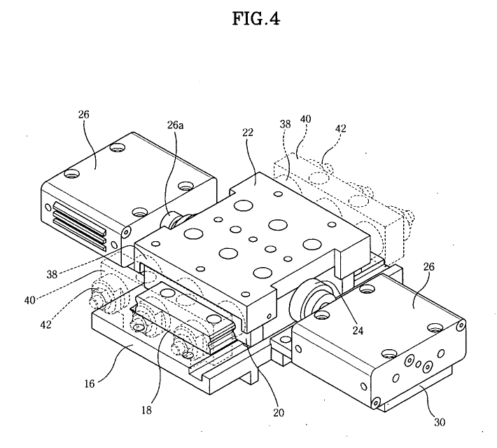

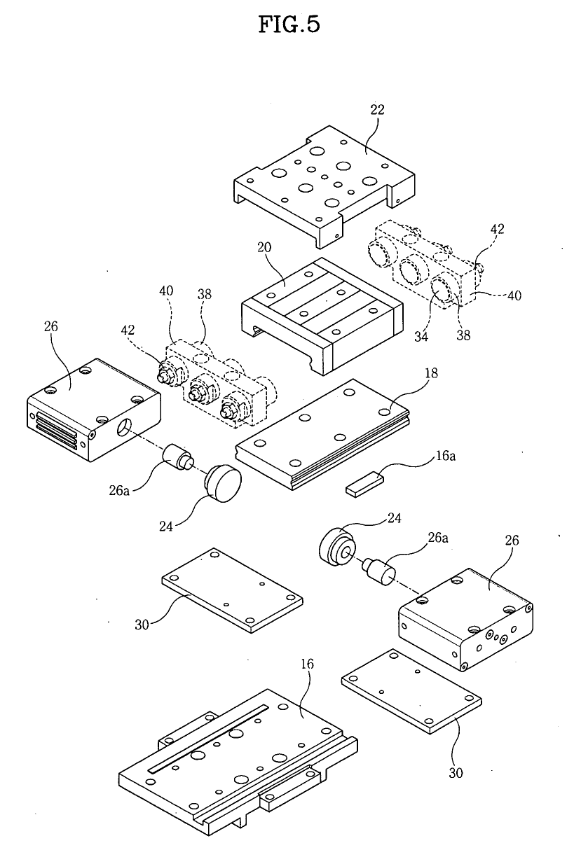

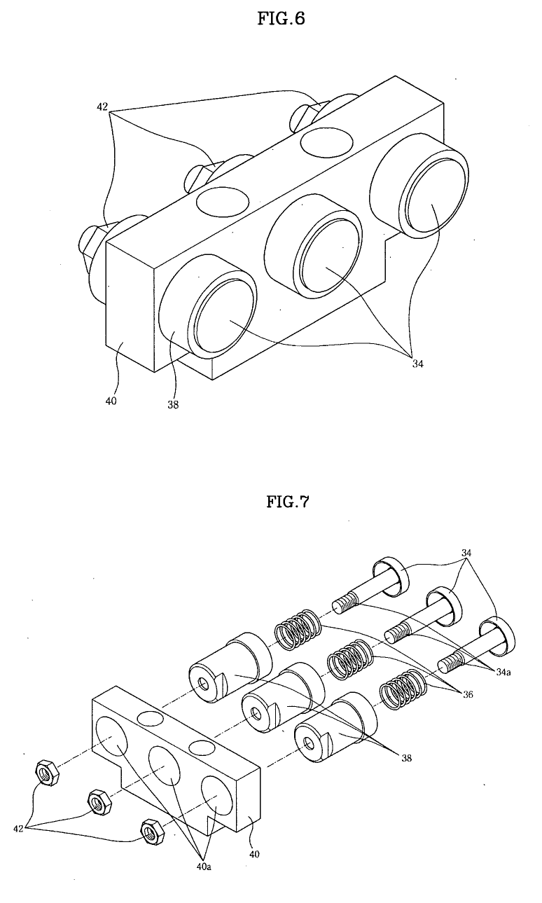

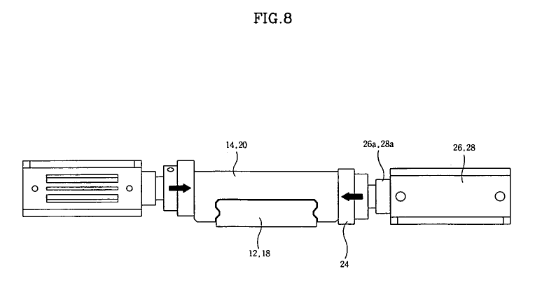

Referring to FIGS. 4 and 5, the slightly longitudinally moving jig includes a middle plate 16 coupled on first linear motion block 14. A second linear motion guide rail 18 is fixed on the middle plate 16 in a longitudinal direction thereof. A second linear motion block 20 is slidably coupled on second linear motion guide rail 18. A second restricting device is fixed on middle plate 16 and restricts a movement of second linear motion block 20 in relation to second linear motion guide rail 18. A second stroke adjuster is fixed on middle plate 16 for adjusting a slight displacement of second linear motion block 20 in relation to second linear motion guide rail 18. An upper plate 22 is placed on second linear motion block 20 and is mounted with a component fixing unit (not shown) used to assemble the door hinge onto the vehicle body mounting portion.

The first and second restricting devices each include a stopper 24 placed at both sides of first linear motion block 14 and second linear motion block 20, respectively, in the moving direction thereof and compressing first linear motion block 14 and second linear motion block 20 for restricting the movement thereof. A first cylinder 26 and second cylinder 28 are placed, respectively, on lower plate 10 and middle plate 16 to provide an actuating force to stopper 24. A first piston 26a and a second piston 28a are movably installed in first and second cylinders 26 and 28, respectively, and compress the rear side of stopper 24.

First cylinder 26 and second cylinder 28 are respectively supported by a first mounting plate 30 and a second mounting plate 32 located each on lower plate 10 and middle plate 16 to face each other.

The first and second stroke adjusters each include a compressor 34 having a head at one end thereof that compresses the front and rear sides of first linear motion block 14 and second linear motion block 20 in the moving direction thereof. A spring 36 provides an elastic force at the rear side of compressor 34. A hollow-shaped housing 38 accommodates compressor 34 and spring 36. A block 40 is installed on each of lower plate 10 and middle plate 16 and has a through hole 40a into which hollow-shaped housing 38 is inserted. An adjusting nut 42 fastens a coupling portion 34a, which is formed at the other end of compressor 34, at a rear side of block 40.

The first and second stroke adjusters, respectively, adjust a slight displacement of first linear motion block 14 and second linear motion block 20 corresponding to the coupled degree of coupling portion 34a of compressor 34 with adjusting nut 42.

Both first cylinder 26 of the slightly laterally moving jig and second cylinder 28 of the slightly longitudinally moving jig are connected to a single pressure pipe 44 (FIG. 1) for supplying the high operation pressure, which activates first and second pistons 26a and 28a, to pressure chambers (not shown). Pressure pipe 44 is installed with an opening and closing valve 46 for adjusting the supply of the operation pressure according to the manipulation of the worker. Pressure pipe 44 is connected to a pressure source providing the high operation pressure. Thus, the operation pressure supplied to first cylinder 26 and second cylinder 28 is controlled by manually manipulating opening and closing valve 46.

Stopper blocks 10a and 16a are installed on lower plate 10 and middle plate 16, respectively, for preventing a detachment of first linear motion block 14 and second linear motion block 20 on first linear motion guide rail 12 and second linear motion guide rail 18.

The operation of the biaxially moving jig of a vehicle door mounting apparatus according to one embodiment of the present invention will now be described below.

Lower plate 10 is coupled to the actuator of the vehicle door mounting apparatus. Next, one end of the door hinge is fixed to the component fixing unit attached to upper plate 22.

The worker drives the vehicle door mounting apparatus to move toward the vehicle body mounting portion delivered via the assembly line then precisely fits the door hinge on the vehicle body mounting portion.

If the locations of the vehicle body mounting portion and the door hinge do not match, the worker can change the position of the door hinge relative to the vehicle body mounting portion by slightly laterally and longitudinally moving first linear motion block 14 and second linear motion block 20 on first linear motion guide rail 12 and second linear motion guide rail 18.

In the above state, opening and closing valve 46 is in a closed state and the operation pressure applied to first cylinder 26 and second cylinder 28 is drained out.

The stroke adjusters adjust the pre-tensioned degree of spring 36 according to the coupled degree of adjusting nut 42 that is coupled on coupling portion 34a of compressor 34. Therefore, while first linear motion block 14 and second linear motion block 20 move in the lateral and longitudinal directions, the amount of the displacement can be restricted, thus preventing the door from contacting a portion other than the vehicle body mounting portion.

Once the door hinge accurately fits on the vehicle body mounting portion, the worker activates the restricting devices by opening the opening and closing valve so as to limit the movement of first linear motion block 14 and second linear motion block 20.

After fixing the position of the door hinge, the worker may couple the door hinge to the vehicle body mounting portion.

As apparent from the foregoing, there is an advantage in that a slight displacement of a door hinge is adjusted while the vehicle door is being assembled via a door mounting apparatus to the vehicle body. Thus, the door hinge precisely fits on the vehicle body mounting portion.

Furthermore, the door assembly of various vehicles is performed with a unitary assembly line, and injuries due to the heavy door mounting apparatus is prevented.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A jig of a vehicle door mounting apparatus wherein the vehicle door mounting apparatus is mounted with one end of a door hinge and carries the other end of the hinge to a vehicle body mounting portion, comprising:
a lower plate coupled to said vehicle door mounting apparatus;
a first linear motion guide rail that is fixed on said lower plate in a lateral direction thereof;
a first linear motion block that is slidably coupled on said first linear motion guide rail;
a first restricting device that is fixed on said lower plate for restricting movement of said first linear motion block;
a first stroke adjuster that is fixed on said lower plate for adjusting a displacement of said first linear motion block;
a middle plate coupled on said first linear motion block;
a second linear motion guide rail that is fixed on said middle plate in a longitudinal direction thereof;
a second linear motion block that is slidably coupled on said second linear motion guide rail;
a second restricting device that is fixed on said middle plate for restricting movement of said second linear motion block;
a second stroke adjuster that is fixed on said middle plate for adjusting a displacement of said second linear motion block;
an upper plate placed on said second linear motion block and mounted with said door hinge;
a pipe for supplying pressure to said first and second restricting devices; and
an opening and closing valve that is installed at said pipe for adjusting opening and closing of said pipe.

2. The jig as defined in claim 1, wherein said first and second restricting devices comprise:
a stopper that is placed at both sides of said first linear motion block and said second linear motion block, in a moving direction thereof and compresses said linear motion blocks for restricting movement thereof;
a first cylinder and a second cylinder placed, respectively, on said lower plate and said middle plate to provide an actuating force to said stopper; and
a first piston and a second piston, installed in said first cylinder and said second cylinder, respectively, for compressing a rear side of said stopper.

3. The jig as defined in claim 2, wherein said first cylinder and said second cylinder are respectively supported by a first mounting plate and a second mounting plate, each located on said lower plate and said middle plate to face each other.

4. The jig as defined in claim 2, wherein said pipe is connected to said first cylinder and said second cylinder.

5. The jig as defined in claim 1, wherein said first and second stroke adjusters comprise:
a compressor that compresses front and rear sides of said first linear motion block and said second linear motion block in a moving direction thereof;
a spring that provides an elastic force to said compressor;
a housing that accommodates said compressor and said spring;
a block that is installed on said lower plate and said middle plate with a through hole in which said housing is disposed; and
an adjusting nut that fastens a coupling portion, at one end of said compressor, at a rear side of said block.
